(19) United States
(12) Patent Application Publication
(10) Pub. No.: US 2012/0181121 A1
(43) Pub. Date: Jul. 19, 2012

(54) Scotch Block for Stationing a Winching Vehicle

(76) Inventors: Thad S. Bailey, Wake Forest, NC (US); Donald Anthony Holt, Youngsville, NC (US)

(21) Appl. No.: 13/351,258

(22) Filed: Jan. 17, 2012

Related U.S. Application Data
(60) Provisional application No. 61/432,806, filed on Jan. 14, 2011.

(51) Int. Cl. B60T 3/00

(52) U.S. Cl. 188/32

(57) ABSTRACT

A scotch block is provided and includes a main frame having one or more cleat bars for digging into the ground in response to a wheel of a towing vehicle engaging and loading the scotch block. The scotch block assumes two modes, an operative mode and an inoperative mode. In the inoperative mode, the scotch block assumes a compact configuration that enables it to be easily handled and stored. In the operative mode, the scotch block is transformed into a device that enables a wheel of a towing vehicle to be supported thereby and during the course of a load being applied to the scotch block during a winching operation, the cleat bars of the scotch block dig into the underlying ground and anchor or station the winching vehicle.

This application claims priority under 35 U.S.C. §119(e) from the following U.S. provisional application: Application Ser. No. 61/432,806 filed on Jan. 14, 2011. That application is incorporated in its entirety by reference herein.

### FIELD OF THE INVENTION

The present invention relates to scotch blocks used to station a vehicle having a winch during a winching operation.

### BACKGROUND OF THE INVENTION

Towing vehicles typically include a winch that is used for various purposes. For example a winch on a towing vehicle can be used to upright an overturned vehicle, align a vehicle with the towing vehicle or pull the vehicle onto a roll-back carrier. These are simple examples of how a winch on a towing vehicle can be used.

Many times the load placed on the winch is so great that the vehicle carrying the winch tends to move and that of course makes it difficult to properly manipulate the vehicle or object being winched. In some cases during a winching operation there is a nearby tree or other structure that can be utilized to station the winching vehicle. In other cases however there are no such trees or other structures closely stationed and which can be used to anchor or station the winching vehicle. In these cases, the tow truck operator has to rely on chock blocks and other devices that engage the wheels of the winching vehicle. These conventional devices tend to be ineffective and also are large and cumbersome to handle.

### SUMMARY OF THE INVENTION

The present invention relates to a scotch block that includes a main frame having one or more cleat bars for digging into the ground in response to a wheel of a towing vehicle engaging and loading the scotch block.

In one embodiment the scotch block assumes two modes—an operative mode and an inoperative or storage mode. In the inoperative mode the scotch block assumes a compact configuration that enables it to be easily handled and stored. In the operative mode the scotch block is transformed into a device that enables a wheel of the towing vehicle to be supported thereby and during the course of a load being applied on the scotch block during a winching operation, the cleat bars of the scotch block dig into the underlying ground and anchor or station the winching vehicle.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view of the scotch block in the inoperative and folded position.

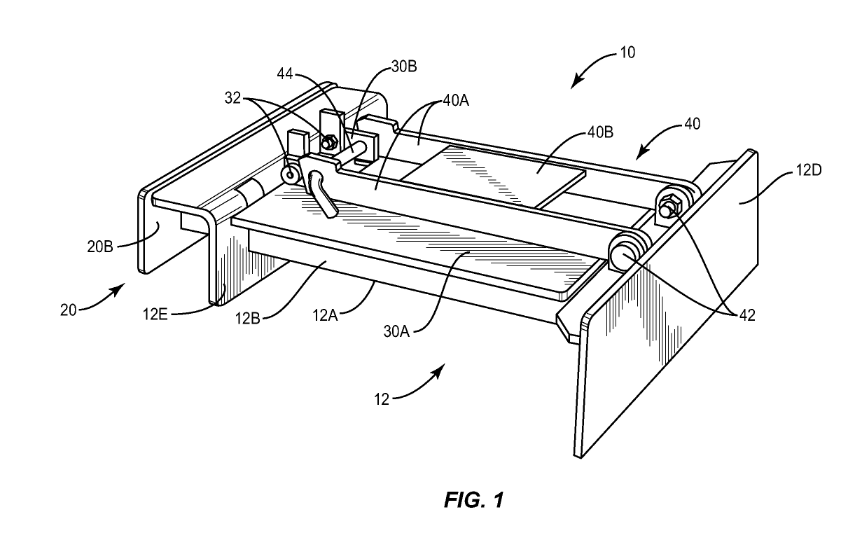

FIG. 2 is a perspective view showing the scotch block the operative position.

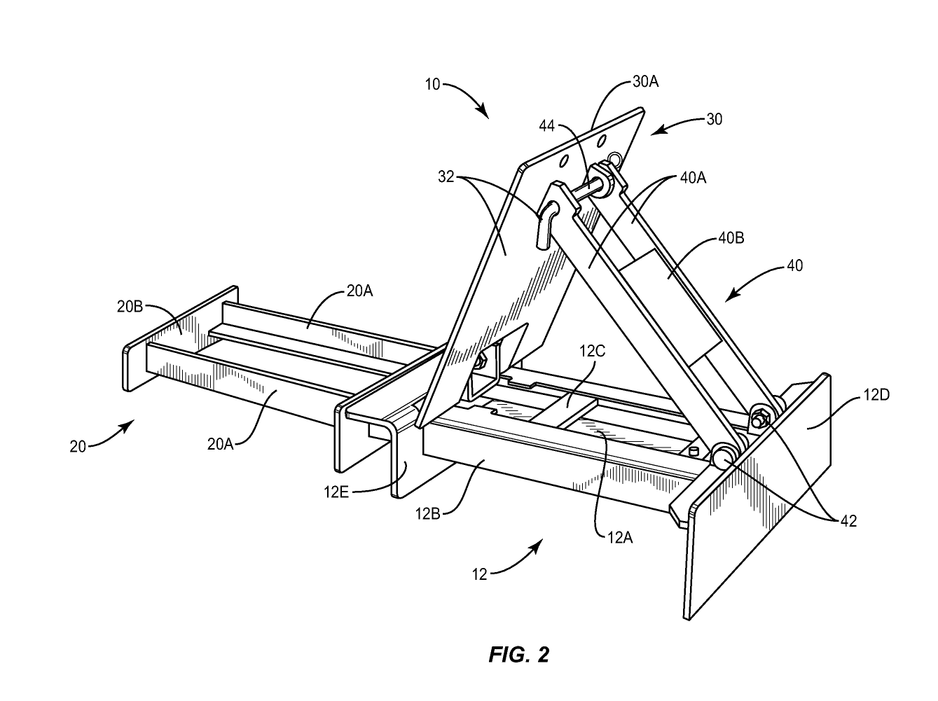

FIG. 3 is a side elevational view showing a wheel of a vehicle engaging the scotch block.

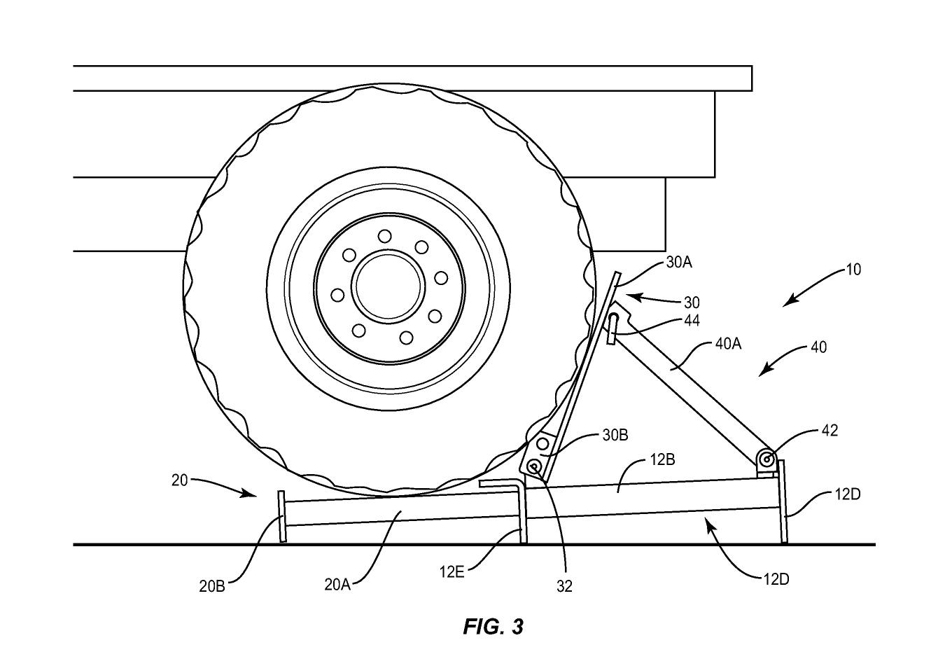

### DESCRIPTION OF AN EXEMPLARY EMBODIMENT

With further reference to the drawings, the scotch block of the present invention is shown therein and indicated generally by the numeral 10. The scotch block 10 as shown in the drawings includes a series of main components including a main frame structure 12, a wheel ramp 20, a wheel stop 30 and a wheel stop support 40. The scotch block 10 could be constructed of various suitable materials. In one embodiment, the scotch block 10 is constructed of heavy gauge steel.

Viewing the main frame structure 12, it is seen that the same includes a U-shaped channel. The U-shaped channel includes a bottom 12A, a pair of sides 12B, and a top 12C. Note that the upper portion of the main frame structure is open at the top. Forming at part of the main frame structure 12 is a front cleat bar 12D and a rear cleat bar 12E.

The wheel ramp 20 is moveable between an extended operative position and a retracted stowed position. In the retracted stowed position, the wheel ramp 20 is retracted into the U-shaped channel of the main frame structure 12. In the operative position, the wheel ramp 20 extends outwardly from the main frame structure. Viewing the structure of the wheel ramp 20, the same includes a pair of rails 20A and an end bar 20B.

Disposed on the main frame structure is the wheel stop indicated generally by the numeral 30. The wheel stop 30 includes a planar plate 30A and a pair for mounting brackets 30B. Lugs extend upwardly from the main frame structure 12 and connectors or fasteners 32 are utilized to connect the lugs to the mounting brackets 30B of the wheel stop 30. More particularly, the fasteners 32 include a pair of pivot pins that extend through the lugs and mounting brackets 30B so as to pivotally connect the wheel stop 30 to the main frame structure. The wheel stop 30 is pivotally mounted for movement between an operative position and a stowed position. In an operative position, the wheel stop 30 extends upwardly and is slightly inclined away from the wheel ramp 20. In the stowed or inoperative position, the wheel stop pivots downwardly and lies in a generally horizontal plane overlying the main frame structure 12.

The wheel stop support 40 is utilized to support the wheel stop 30 in the operative position. As shown in the drawings, the wheel stop support 40 is pivotally mounted for movement between an operative position and a stowed position. In the operative position, the wheel stop support extends at an incline from the main frame structure 12 upwardly to where it connects to the back of the wheel stop 30. This enables the wheel stop support 40 to support the wheel stop 30 when in the operative position.

Viewing the wheel stop support 40 in more detail, the same includes a pair of elongated bars 40A. There is provided an interconnecting structure 40B that is interconnected between the elongated bars or members 40A. One end of the wheel stop support 40 is pivotally connected to the main frame structure generally above the front cleat bar 12D. A pair of pivot pins 42 connect the wheel stop support 40 to the main frame structure 12. The upper portion or the opposite end portion of the wheel stop support 40 is connected to the back of the wheel stop 30 by a retractable pin 44. The retractable pin 44 extends through openings formed in the end portion of the wheel stop support 40 and through a pair of lugs that extend from the back side of the wheel stop 30. This enables the wheel stop support 40 to be quickly and easily attached and detached with respect to the wheel stop 30. When the wheel stop support 40 assumes the stowed or inoperative position, it is folded downwardly to a position overlying the main frame structure 12. In the inoperative position, the wheel stop support 40 is disposed in a generally horizontal plane overlying the main frame structure. In the embodiment illustrated herein, in the stowed position the wheel stop support 40 overlies the wheel stop 30 which is disposed in the stowed or inoperative position over the U-shaped channel of the main frame structure. It is appreciated that it is possible for this to be reversed as the wheel stop support 40 could be disposed directly adjacent the main frame structure 12 when in the inoperative or stowed position and the wheel stop 30 could be disposed over the wheel stop support. In any event, when in the inoperative or stowed position, both the wheel stop 30 and the wheel stop support 40 are folded downwardly such that they overlie the main frame structure.

In the operative position, the wheel ramp 20 is extended as shown in the drawings and the wheel stop 30 and the wheel stop support 40 are extended to where the wheel stop and the wheel stop support form a generally A-frame structure overlying the main frame structure.

In use, a wheel of a towing vehicle is caused to ride up and over the wheel ramp 20 until a portion of the wheel engages the wheel stop 30. Then when the winching vehicle is utilized to winch a load, the force created with cause the wheel of the winching vehicle to push forwardly towards the front portion of the scotch block 10. This load will cause the front cleat bar 12D and the rear cleat bar 12E to penetrate and dig into the ground or into another underlying surface, causing the scotch block 10 to be anchored to the ground.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A scotch block assembly, comprising:
a main frame structure;
a retractable wheel ramp associated with the main frame structure and moveable back and forth between a retracted position where the wheel ramp is retracted into the main frame structure and an extended position where the wheel ramp extends out from the main frame structure;
a wheel stop moveably mounted to the main frame structure for movement between an inclined operative position and a stowed position;
a wheel stop support mounted to the main frame structure and moveable between an operative position and a stowed position;
wherein in the operative position the wheel stop support extends upwardly and is operatively connected to the wheel stop when the wheel stop is in the inclined operative position; and
wherein the scotch block assembly is configured to be supported on a surface and operative to engage a wheel of a vehicle to prevent the vehicle from moving past the wheel stop.

2. The scotch block assembly of claim 1 further including a cleat bar forming a part of the main frame structure for engaging the surface underlying the scotch block assembly.

3. The scotch block assembly of claim 2 further including two cleat bars secured to the main frame structure and wherein the two cleat bars are spaced apart.

4. The scotch block assembly of claim 1 wherein in the stowed position the wheel stop and the wheel stop support overlie the main frame structure.

5. The scotch block assembly of claim 4 wherein in the stowed position the wheel stop and wheel stop support lie above the main frame structure in generally horizontal planes.

6. The scotch block assembly of claim 1 wherein the wheel stop is pivotally connected to the main frame structure and wherein the wheel stop support is also pivotally connected to the main frame structure.

7. The scotch block assembly of claim 1 wherein the wheel stop comprises a generally planar plate and wherein the wheel stop support comprises at least a pair of elongated members that are spaced apart with respect to each other.

8. The scotch block assembly of claim 1 wherein the wheel ramp includes a pair of spaced apart rails and an end bar secured to an end portion of the rails.

9. A scotch block assembly comprising:
a main frame structure;
a retractable wheel ramp associated with the main frame structure and moveable back and forth between a retracted position where the wheel ramp is retracted into the main frame structure and an extended position where the wheel ramp extends outwardly from the main frame structure;
a wheel stop pivotally mounted to the main frame structure for movement between an inclined operative position and a stowed position, and wherein in the stowed position the wheel stop assumes a generally horizontal position with respect to the main frame structure;
a wheel stop support pivotally mounted to the main frame structure and moveable between an operative position and a stowed position;
in the operative position, the wheel stop support extends upwardly from the main frame structure and is operatively connected to the wheel stop when the wheel stop assumes the operative position;
wherein the wheel stop support in the stowed position assumes a generally horizontal position with respect to the main frame structure;
wherein when the wheel stop and the wheel stop support assume their operative position, the wheel stop and the wheel stop support form an A-frame configuration;
a detachable fastener for fastening the wheel stop support to the wheel stop; and
wherein the main frame structure includes at least one cleat bar that is configured to engage an underlying surface when a wheel of a vehicle engages and pushes against the wheel stop.

10. The scotch block assembly of claim 9 wherein the wheel stop includes a plate and wherein the wheel stop support includes at least two elongated members that extend generally between the wheel stop and the main frame structure when the wheel stop support and the wheel stop assume the operative position.

11. The scotch block assembly of claim 9 wherein the main frame structure includes a generally U-shaped channel and wherein the wheel ramp is retractable into the U-shaped channel.

12. The scotch block assembly of claim 9 wherein the U-shaped channel forming a part of the main frame structure includes at least a partially open top.

13. The scotch block assembly of claim 9:
wherein the wheel stop includes a plate and wherein the wheel stop support includes at least two elongated members that extend generally between the wheel stop, the main frame structure when the wheel stop support and the wheel stop assume the operative position; and
wherein the main frame includes a general U-shaped channel and wherein the wheel ramp is retractable into the U-shaped channel.
